(19) United States
(12) Patent Application Publication
(10) Pub. No.: US 2004/0149524 A1
(43) Pub. Date: Aug. 5, 2004

(54) Cable brake at a speed limiter for lifts

(76) Inventors: Peter Mori, Rothenburg (CH); Walter Windlin, Ennetmoos (CH)

Correspondence Address: Jay A. Bondell, Esq., SCHWEITZER CORNMAN GROSS & BONDELL LLP, 292 Madison Avenue, New York, NY, 10017, US

(21) Appl. No.: 10/737,255

(22) Filed: Dec. 15, 2003

Related U.S. Application Data
(63) Continuation of application No. PCT/CH02/00340, filed on Jun. 25, 2002.

(30) Foreign Application Priority Data
Jun. 29, 2001 (EP) 01810631.0

(51) Int. Cl. B66B 5/00; B66B 5/04

(52) U.S. Cl. 187/373; 187/350

(57) ABSTRACT

A lower rate of wear of brake blocks and a speed limiter cable for a lift speed limiter brake apparatus and thus a longer service life can be achieved with a cable brake having brake blocks of different materials. In a preferred embodiment, one of the brake blocks is of aluminium-bronze and the other brake block is of nodular cast iron or soft cast iron. In further embodiments, one or both of the brake blocks may be formed of a ceramic-containing material.

The present application is a continuation of PCT/CH02/00340, filed 25 June, 2002.

The invention relates to a cable brake at a speed limiter for lifts, wherein the cable brake comprises two brake blocks.

### BACKGROUND OF THE INVENTION

Lift cable brakes are actuated by the lift's speed limiter when a permissible speed is exceeded, whereby a limiter cable, guided over a cable pulley of the speed limiter and fixedly connected with a lift cage, is braked and a safety brake is triggered by means of which the lift cage is brought to a stop.

A speed limiter with a cable brake which comprises non-movable and movable brake blocks, has been made known by German Patent Specification 25 28 067. The movable brake block is secured to a yoke guided in a cable brake housing. Two levers each disposed under the effect of a respective compression spring are pivotably coupled at one end to two pins mounted in the yoke and are rotatably mounted at the other end at two axles mounted in the cable brake housing. The compression springs are each biased between two discs, wherein one disc bears against a shoulder of the lever and the other disc bears against the axle and wherein a displacement of the lever and thus also of the movable block shoe in the effective direction of the compression springs is made possible in slots provided in the levers. An actuating plate is provided at the yoke, by means of which an actuating arm of the speed limiter can displace the movable brake block from an open setting into a braking setting. The brake blocks usually consist, in the case of cable brakes of the afore-described kind, either of aluminium-bronze (CuAl) or of nodular cast iron (GGG). A good braking effect is achieved with brake blocks of aluminium-bronze. The heat liberated by the braking is rapidly dissipated, but the wear is considerable in the case of long braking travels. The brake blocks of nodular cast iron have a poorer braking effect. They wear less, but cannot dissipate the braking heat well. Moreover, wear of the limiter cable has to be taken into account.

The present invention is directed to a cable brake according to the introduction in which the afore-mentioned disadvantages of the brake block material are of less consequence.

### BRIEF DESCRIPTIONS OF THE INVENTION

In accordance with the foregoing and other objects, a cable brake in accordance with the present invention comprises a brake having two brake blocks, each of which is of a different material. In a preferred embodiment one brake block consists of aluminium-bronze and the other brake block consists of nodular cast iron or soft cast iron. Particularly effective embodiments similarly have two brake blocks of different materials, wherein in each instance one of the brake blocks consists of a material containing ceramic.

In a further embodiment, both brake blocks may consist of a material containing ceramic.

The advantages achieved by the invention are to be seen in that the favourable properties of both materials can be utilized. During braking, the heat is conducted away from the limiter cable, particularly by the brake block of aluminium-bronze, which has a positive effect on cable wear. The brake block of nodular cast iron ensures low wear. The advantages of ceramic embodiments reside in the high wear resistance and heat tolerance of the material containing ceramic.

### BRIEF DESCRIPTIONS OF THE INVENTION

The invention is explained in more detail in the following description of illustrative embodiments, in conjunction with the drawings, in which:

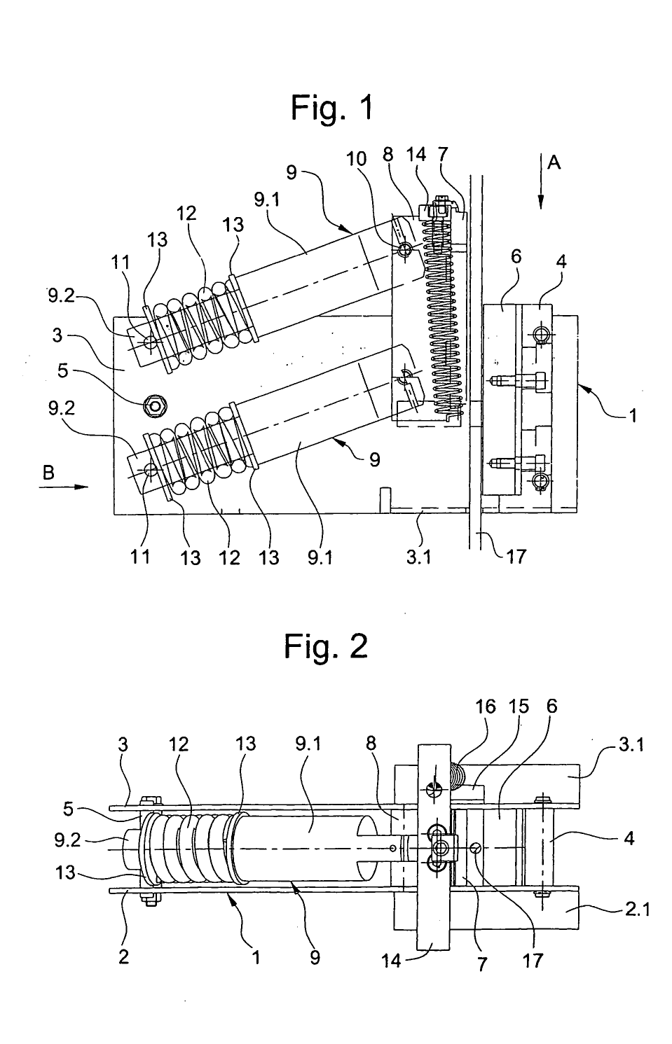

FIG. 1 is a side elevation view of a cable brake embodying the invention;

FIG. 2 is a plan view of the cable brake in the direction A of FIG. 1; and

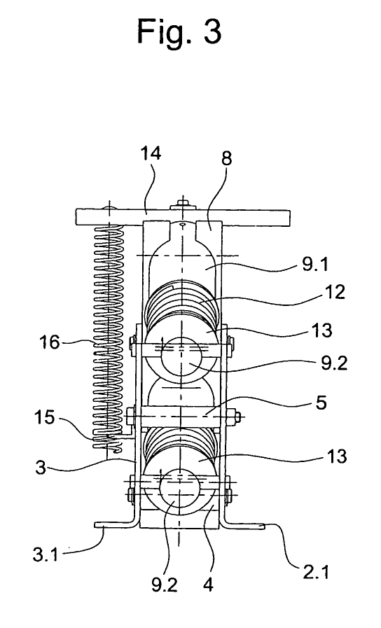

FIG. 3 shows an end elevation view of the cable brake in the direction B of FIG. 1.

### DETAILED DESCRIPTION OF THE INVENTION

In FIGS. 1 to 3 a brake housing is denoted by 1, which consists of two side members 2, 3 with bent flanges 2.1, 3.1. The side members 2, 3 are connected together by way of a spacer member 4 and a spacer tube 5. A non-movable brake block 6, which, for example, is of nodular cast iron (GGG) or soft cast iron, is fastened to the spacer member 4. A movable brake block 7, which, for example, is of aluminium-bronze (CuAl), is connected with a guide member 8 extending between the side members 2, 3 of the brake housing 1.

Two telescopic levers 9 each comprise a respective cylinder part 9.1 and piston part 9.2. The cylinder parts 9.1 are each pivotably coupled to a pin 10 mounted at the guide member 8, whereas the piston parts 9.2 are each rotatably mounted at an axle 11 arranged in the brake housing 1. Compression springs 12, which are supported at their ends by way of opposed discs 13 on the axles 11 and on the cylinder parts 9.1, are arranged on the piston parts 9.2. A tension spring 16 is tensioned between a cross member 14 fastened to the guide member 8 and a bracket 15 arranged at the brake housing 1. The cross member 14 is supported on an actuating element of a speed limiter (not illustrated) so that the components—cross member 14, guide member 8 and brake block 7—guided at the telescopic levers 9 are held in an upper setting or position.

When the permissible speed of a lift cage is exceeded, the actuating element is so displaced that it no longer supports the cross member 14, so that the guide member 8 together with the movable brake block 7 drops downwardly and the brake block 7 is pressed by the compression springs 12 against a limiter cable 17 running between it and the non-movable brake block 6. The limiter cable 17 is thereby braked and a safety brake tripped.

It is also possible to use aluminium-bronze (CuAl) for the non-movable brake block 6 and nodular cast iron (GGG) or soft cast iron (GG) for the movable brake block 7. In addition, instead of the different metals or alloys, a material containing ceramic can be used for one of the brake blocks or for both brake blocks.

It is within the scope of the invention to equip brake blocks of like material with brake linings of different material, wherein the aforesaid materials are preferably used for the brake linings.

We claim:

1. A cable brake for a speed limiter for lifts, wherein the cable brake comprises two brake blocks, each of the brake blocks being of a different material.

2. The cable brake according to claim 1, characterised in that one brake block is of aluminium-bronze and the other brake block is of nodular cast iron or soft cast iron.

3. The cable brake according to claim 2, characterised in that the brake comprises a movable and a non-movable brake block, the non-movable brake block being of nodular cast iron or soft cast iron and the movable brake block being of aluminium-bronze.

4. The cable brake according to claim 2, characterised in that the brake comprises a movable and a non-movable brake block, non-movable brake block being of aluminium-bronze and the movable brake block being of nodular cast iron or soft cast iron.

5. The cable brake according to claim 1, characterised in that one of the two brake blocks consists of a ceramic-containing material.

6. The cable brake according to claim 1, characterised in that one of the two brake blocks comprises a ceramic-containing material containing and the other brake block comprises aluminium-bronze, nodular cast iron or soft cast iron.

7. A cable brake for a speed limiter for lifts, wherein the cable brake comprises two brake blocks characterised in that the brake blocks each comprise a ceramic-containing material.
